(19) United States
(12) Patent Application Publication
(10) Pub. No.: US 2026/0080441 A1
(43) Pub. Date: Mar. 19, 2026

(54) DISTRIBUTION DEVICE AND CONTENT DISPLAY METHOD

(71) Applicant: Sharp Display Solutions, Ltd., Tokyo (JP)

(72) Inventor: Akira UCHIYAMA, Tokyo (JP)

(21) Appl. No.: 19/403,401

(22) Filed: Nov. 28, 2025

Related U.S. Application Data
(63) Continuation of application No. PCT/JP2023/034102, filed on Sep. 20, 2023.

(51) Int. Cl. G06Q 30/0241; G06F 11/16; G06Q 30/0273

(52) U.S. Cl. CPC G06Q 30/0277; G06F 11/162; G06Q 30/0273

(57) ABSTRACT

A content display method executed by a distribution device communicatively connected to a plurality of display devices and configured to distribute a content to the plurality of display devices. A failure display device, in which a failure has occurred, is detected from among the plurality of display devices. A replacement display device is extracted from one or more non-failure display devices, in which any failure has not been detected. The one or more non-failure display devices are included in the plurality of display devices. The extraction is made on the basis of the degree of similarity in display condition between the one or more non-failure display devices and the failure display device. A content, which had once been assigned to be displayed on the failure display device, is transmitted toward the replacement display device as extracted, and to allow the replacement display device to display the content.

### TECHNICAL FIELD

The present invention relates to a distribution device and a content display method.

### BACKGROUND ART

In digital signage systems at stations and airports, a plurality of display devices are installed within the same network, and advertisement contents are displayed on each display device. In such digital signage systems, it is possible to set advertisement contents to be displayed for each display device. In such digital signage systems, when a failure occurred in a specific display device, advertisement contents that had been displayed until then on the display device were no longer be able to be displayed (Patent Document 1 and Patent Document 2).

### CITATION LIST

### Patent Document

Patent Document 1: Japanese U.S. Pat. No. 6,251,487

Patent Document 2: Japanese Unexamined Patent Application, First Publication No. 2021-182085

### SUMMARY OF INVENTION

### Technical Problem

A display device with a self-diagnosis function can determine whether an image or video being displayed on a display device is being displayed normally. Thus, when a failure is detected in the display device that configures a digital signage system, it is possible to immediately notify an administrator of information on the display device to stop the generation of advertising fees. However, even when the generation of advertising fees can be stopped at an early stage in the case of a failure of a display device, it may result in an opportunity loss for an advertisement placing source, and it may also result in a decrease in profits for a placing destination.

In view of the above problems, an object of the present invention is to provide a distribution device and a content display method which are capable of compensating for advertising opportunities when an issue such as a failure of a specific display device occurs in an environment where there are a plurality of display devices on the same network.

### Solution to Problem

A content display method according to one aspect of the present invention is a content display method executed by a content display method executed by a distribution device that is communicably connected to a plurality of display devices and distributes a content to the plurality of display devices, the content display method including detecting a display device in which a failure has occurred among the plurality of display devices, extracting a replacement display device from among the display devices in which a failure has not been detected, on the basis of the degree of similarity between a display condition of a display device in which no failure has been detected and a display condition of the display device in which a failure has been detected, and transmitting a content assigned to be displayed on the display device in which a failure has been detected to the extracted replacement display device, and displaying the content.

In addition, an advertisement display method according to one aspect of the present invention is a content display method executed by a distribution device that is communicably connected to a plurality of display devices and distributes a content to the plurality of display devices, the content display method including detecting a display device in which a failure has occurred among the plurality of display devices, extracting a replacement display device from among the display devices in which no failure has been detected, in accordance with a correspondence between a consumer attribute of a content assigned to be displayed on the display device in which a failure has been detected and a consumer attribute of a content assigned to be displayed on the display device in which no failure has been detected, and transmitting a content assigned to be displayed on the display device in which a failure has been detected to the extracted replacement display device, and displaying the content.

Further, an advertisement display method according to one aspect of the present invention is a distribution device that is communicably connected to a plurality of display devices and distributes a content to the plurality of display devices, the distribution device including a detection unit that detects a display device in which a failure has occurred among the plurality of display devices, an extraction unit that extracts a replacement display device from among the display devices in which a failure has not been detected, and a transmission unit that transmits a content assigned to be displayed on the display device in which a failure has been detected to the replacement display device.

Further, an advertisement display method according to one aspect of the present invention is a distribution device that is communicably connected to a plurality of display devices and distributes a content to the plurality of display devices, the distribution device including a detection unit that detects a display device in which a failure has occurred among the plurality of display devices, an extraction unit that extracts a replacement display device from among the display devices in which no failure has been detected, in accordance with a correspondence between a consumer attribute of a content assigned to be displayed on the display device in which a failure has been detected and a consumer attribute of a content assigned to be displayed on the display device in which no failure has been detected, and a transmission unit that transmits a content assigned to be displayed on the display device in which a failure has been detected to the extracted replacement display device.

### Advantageous Effects of Invention

According to the present invention, it is possible to display an advertisement that can no longer be displayed due to a failure of a display device on another display device instead. Thereby, when an issue such as a failure of the display device occurs, it possible to compensate for an advertising opportunity.

### BRIEF DESCRIPTION OF DRAWINGS

FIG. 1 A diagram of an outline of a digital signage system according to a first embodiment of the present invention.

FIG. 2 A schematic functional block diagram explaining the functions of a content server 11.

FIG. 3 A schematic functional block diagram showing an example of a configuration of a display device 12.

FIG. 4 A flowchart showing a process in the digital signage system according to the first embodiment of the present invention.

FIG. 5 A diagram showing a database of information on a display device in the first embodiment of the present invention.

FIG. 6 A diagram showing an example of composite display of advertisement contents in the first embodiment of the present invention.

FIG. 7 A diagram showing another example of composite display of advertisement contents in the first embodiment of the present invention.

FIG. 8 A flowchart showing a process in a digital signage system according to a second embodiment of the present invention.

FIG. 9 A diagram showing a database of information on a display device in the second embodiment of the present invention.

FIG. 10 A block diagram showing a basic configuration of an advertisement display device in another aspect of the present invention.

### DESCRIPTION OF EMBODIMENTS

Hereinafter, embodiments of the present invention will be described with reference to the drawings.

### First Embodiment

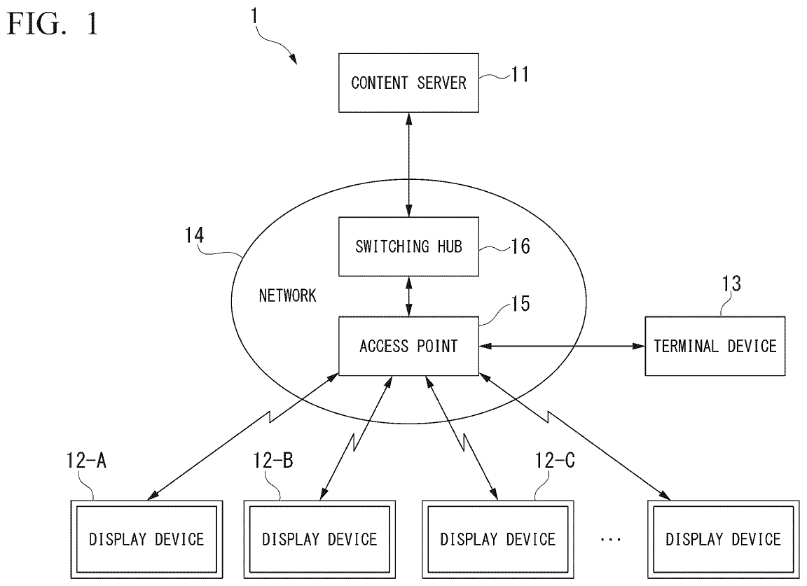

FIG. 1 is a diagram of an outline of a digital signage system according to a first embodiment of the present invention. As shown in FIG. 1, a digital signage system 1 according to the first embodiment of the present invention is configured by connecting a content server (distribution device) 11, a plurality of display devices 12-A, 12-B, 12-C,. and a terminal device 13 via the same network 14. An access point 15 and a switching hub 16 configure the network 14 that connects the content server 11, the plurality of display devices 12-A, 12-B, 12-C, . . . , and the terminal device 13.

The content server 11 is communicatively connected to a plurality of display devices via the network 14, and distributes contents to the plurality of display devices.

The content server 11 is, for example, a distribution device.

The content server 11 displays the contents by transmitting them to the display devices (display devices 12-A, 12-B, 12-C, . . . ).

The contents include at least one of still image data, video data, sound data, and text data. In this embodiment, a case where the contents are advertisements is described, but the contents do not need to be advertisements. Advertisement contents can be divided into an own company's advertisements and other companies'advertisements. For example, an own company's advertisements are advertisements placed by a distribution company that provides a service of transmitting the content to each display device and displaying it. The distribution company transmits the content and manages and operates various facilities. An own company's advertisements may include not only promotional advertisements but also information such as train and airline guides and service schedules. Other companies'advertisements are advertisements placed by a company other than the distribution company that provides a service of transmitting and displaying contents to each display device. Other companies'advertisements may be advertisements for surrounding retail stores and the like in a station or airport facility. Further, in the digital signage system 1 according to the first embodiment of the present invention, a contents management system (CMS) is used to manage advertisement contents.

The display devices 12-A, 12-B, 12-C, . . . are installed at different locations, for example, in various places in a station or an airport, and display contents. For example, a liquid crystal display (LCD) display, an electro luminescence (EL) display, and the like are used as the display devices 12-A, 12-B, 12-C, . . . The display devices 12-A, 12-B, 12-C, . . . display contents in accordance with scheduling. In this embodiment, the display devices 12-A, 12-B, 12-C, . . . have a self-diagnosis function.

The terminal device 13 is, for example, a personal computer (PC). The administrator can input operations from an input device provided in the terminal device 13 to cause the content server 11 to execute processes such as editing and scheduling of advertisement contents to be displayed on the display devices 12-A, 12-B, 12-C, . . .

Next, description will be given of a process when a failure occurs in any of the display devices 12-A, 12-B, 12-C, . . . in the digital signage system 1 according to the first embodiment of the present invention.

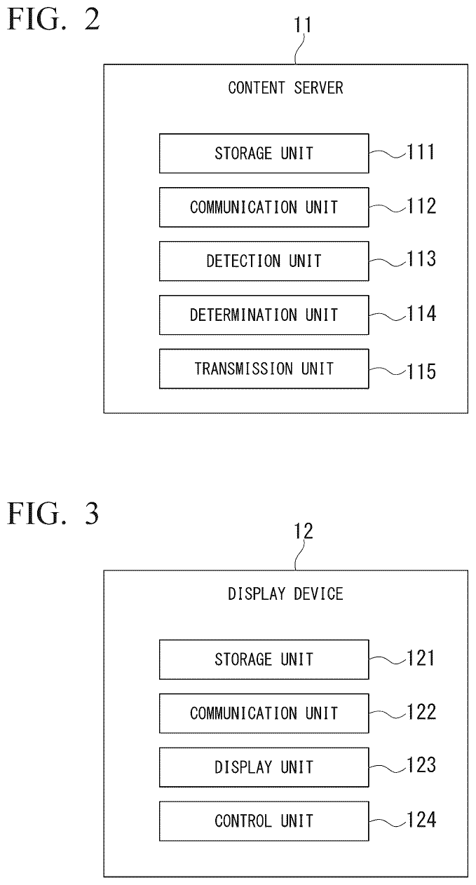

FIG. 2 is a schematic functional block diagram showing the functions of the content server 11.

The content server 11 includes a storage unit 111, a communication unit 112, a detection unit 113, a determination unit 114, and a transmission unit 115.

The storage unit 111 stores various data. For example, the storage unit 111 stores information such as display conditions of the display device and the time of display of a content.

The communication unit 112 communicates with each display device and the terminal device 13 via the network 14.

The detection unit 113 detects a display device in which a failure has occurred among the plurality of display devices. For example, the detection unit 113 installs an imaging device that captures an image of a display screen near each of the display devices 12-A, 12-B, 12-C, . . . , and the content server 11 acquires image data captured by the imaging device. The detection unit 113 may then analyze the acquired image data and detect whether a failure has occurred in the display device on the basis of the analysis result. The image data may be analyzed so that it is determined whether there is a correspondence between an analysis result of the image data when the content is displayed normally and an analysis result of the image data acquired from the imaging device. The detection unit 112 may detect that no failure has occurred when there is a correspondence in accordance with the determination result, and may detect that a failure has occurred when there is no correspondence.

The extraction unit 114 extracts a replacement display device from among display devices in which no failure has been detected. The replacement display device is a display device that displays a content that should have been displayed on the display device in which a failure has occurred, instead of the display device in which a failure has been detected.

The extraction unit 114 extracts a display device as a replacement display device on the basis of the degree of similarity between display conditions of the display device in which no failure has been detected and display conditions of the display device in which a failure has been detected. The display conditions of the display device include physical conditions of the display device and conditions based on a method for use. The physical conditions include a screen size, an installation location, an aspect ratio, a resolution, and the like. The conditions based on the method for using include a fee for use and viewer attributes. The viewer attributes represent the attributes of a target that is desired to view the content. In other words, the viewer attributes represent the attributes of a target to which the content is to appeal. In addition, when the content is an advertisement, the attributes of consumers who are likely to purchase a product which is a target to be appealed to by the advertisement can be used as the viewer attributes. In this case, the viewer attributes can also be said to be consumer attributes.

The degree of similarity can be considered high when a combination of a plurality of display conditions includes a large number of elements included in the display conditions that have the same contents (values). In addition, even when the contents (values) of the elements included in the display conditions are not the same, the degree of similarity can be considered high when the values are close to each other.

When a first content that has been assigned to be displayed on the display device in which a failure has been detected is displayed on the replacement display device, and there is a second content that has been assigned to be displayed on the replacement display device, the extraction unit 114 extracts the first content and the second content. That is, the extraction unit 114 can extract a content that was intended to be displayed on the display device in which a failure was detected and a content that was intended to be displayed on the replacement display device.

The extraction unit 114 refers to viewer attributes of a content that was intended to be displayed on the display device in which a failure was detected, and extracts a replacement display device in accordance with the viewer attributes.

The content server 11 refers to consumer attributes of an advertisement content displayed on a faulty display device. That is, in a targeted signage, an advertisement content is displayed in accordance with the attributes of a consumer who will view the advertisement.

The extraction unit 114 refers to viewer attributes of the content that was intended to be displayed on the display device in which a failure was detected, and extracts a replacement display device in accordance with the viewer attributes.

The extraction unit 114 refers to consumer attributes of a content that was assigned to be displayed on the display device in which a failure was detected, and extracts, as a replacement display device, a display device that does not include a content targeted at the same viewer attributes as those of display device in which a failure was detected, from among the display devices in which a failure was not detected.

The transmission unit 115 causes the communication unit 112 to transmit, to the replacement display device, the content that was assigned to be displayed on the display device in which a failure was detected.

The transmission unit 115 transmits the first content and the second content to the replacement display device.

The transmission unit 115 transmits the first content and the second content to the replacement display device, thereby displaying the first content in a first region among divided regions of the replacement display device and displaying the second content in a second region among the divided regions.

The transmission unit 115 transmits the first content and the second content to the replacement display device, thereby displaying the first content and the second content on a display screen of the replacement display device in order over time. This order may be the order of the first content and the second content, or may be the order of the second content and the first content, or the first content and the second content may be displayed alternately and repeatedly.

FIG. 3 is a schematic functional block diagram showing an example of the configuration of the display device 12.

The display device 12 includes a storage unit 121, a communication unit 122, a display unit 123, and a control unit 124.

The storage unit 121 stores various data.

The communication unit 122 communicates with the content server 11 via the network 14.

The display unit 123 displays contents. The display unit 123 is, for example, a liquid crystal display panel.

The control unit 124 controls each unit of the display device 12. For example, the control unit 124 can divide one display region of the display unit 123 provided on the display device 12 into a plurality of divided display regions and can display a different content in each of the divided display regions (divided display regions).

The control unit 124 also has a self-diagnosis function. The self-diagnosis function is a function of diagnosing whether the display device 12 itself is in a state where it can normally display a content. When a failure is detected using the self-diagnosis function, the control unit 124 transmits a notification indicating that a failure has been detected to the content server 11. Thereby, the detection unit 113 of the content server 11 can detect that a failure has occurred in the display device that has transmitted the notification indicating that a failure has been detected.

When a failure occurs in any of the display devices 12-A, 12-B, 12-C, . . . , an advertisement content that had been displayed until then on the display device will no longer be able to be displayed. When an advertisement content is another company's advertisement, an advertising client has paid an advertising fee, and thus when the advertisement can no longer be displayed due to a failure in the display device, it is necessary to compensate for a loss due to the lost advertising opportunity. Consequently, in this embodiment, when there is a display device in which a failure occurs among the display devices 12-A, 12-B, 12-C, . . . , a replacement display device is specified from among the display devices that are operating normally, and the advertisement content is displayed on the replacement display device instead of the faulty display device, thereby compensating for the advertising opportunity due to the failure in the display device.

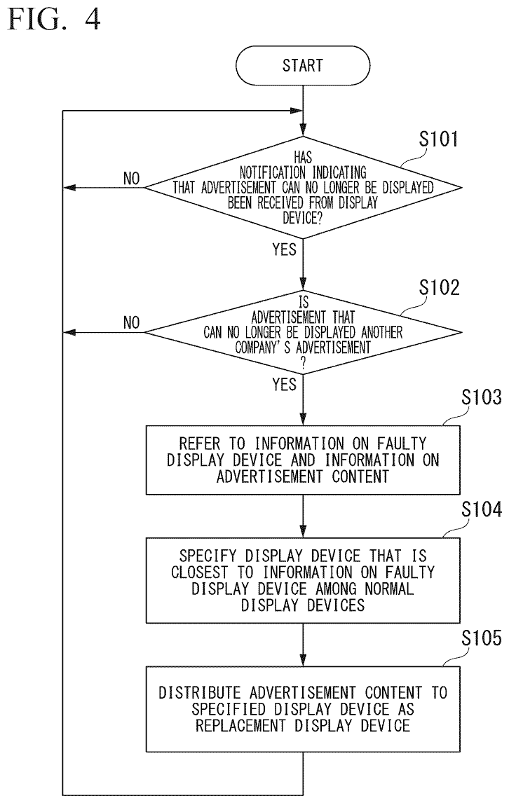

FIG. 4 is a flowchart showing a process in the digital signage system 1 according to the first embodiment of the present invention. This flowchart shows a process when a failure occurs in one of the display devices 12-A, 12-B, 12-C, . . . while advertisements are being displayed on the display devices 12-A, 12-B, 12-C, . . . in accordance with scheduling.

(step S101) The content server 11 determines whether it has received a notification indicating that an advertisement can no longer be displayed from each of the display devices 12-A, 12-B, 12-C, . . . That is, in this embodiment, each of the display devices 12-A, 12-B, 12-C, . . . has a self-diagnosis function. When each of the display devices 12-A, 12-B, 12-C, . . . cannot normally display an advertisement content due to a cause such as a failure, the display device transmits a notification indicating that a failure has occurred in response to a status acquisition command received from the content server 11. The content server 11 determines whether it has received a notification from the display device, thereby specifying a display device in which a failure has occurred among the display devices 12-A, 12-B, 12-C, . . .

In step S101, when the content server 11 has not received a notification indicating that an advertisement can no longer be displayed from any of the display devices 12-A, 12-B, 12-C, . . . (step S101: No), the content server 11 returns the process to step S101. In addition, when the content server 11 has received a notification indicating that an advertisement can no longer be displayed (step S101: Yes), the content server 11 causes the process to proceed to step S102.

(step S102) When the content server 11 receives a notification indicating that an advertisement can no longer be displayed from any of the display devices 12-A, 12-B, 12-C, . . . (step S101: Yes), it determines whether the advertisement content that can no longer be displayed is an own company's advertisement or another company's advertisement. When the advertisement content that can no longer be displayed is own company's advertisement (step S102: No), the content server 11 returns the process to step S101, and when it is another company's advertisement (step S102: Yes), the content server 11 causes the process to proceed to step S103.

As described above, advertisement contents can be classified as own company's advertisements and other companies'advertisements. Own company's advertisements can be placed on the basis of determination of the company, but other companies'advertisements are sold as advertisement frames for advertisement contents to be displayed, and the other companies place the advertisements there. For this reason, when the advertisements of the other companies are not displayed, a loss may occur.

In order to distinguish whether an advertisement content is own company's advertisement or another company's advertisement, an identifier for own company/another company may be added to data of the advertisement content in advance.

(step S103) The content server 11 refers to information on a faulty display device and information on the content.

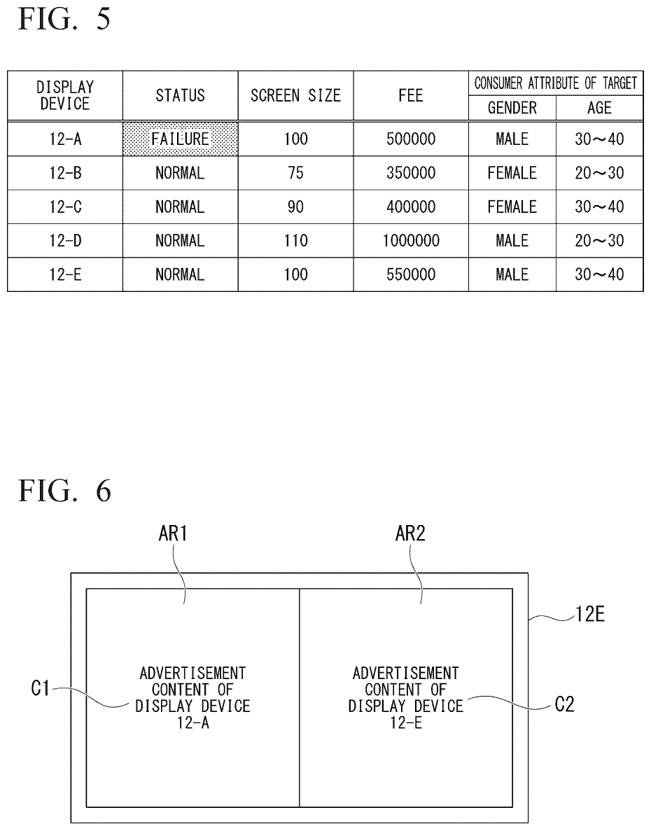

FIG. 5 is a diagram showing an example of display conditions of a display device. Such display conditions of the display device may be stored in advance in the storage unit 111 as a database. In the example of FIG. 5, the display conditions of the display device include elements such as “status”, “screen size”, “fee”, and “consumer attribute”. The “status” indicates whether the display device is faulty or normal. The “screen size” indicates the size of the screen of the display device. The “fee” is a fee for using the display device for a certain period of time. For example, the fee is a fee incurred when the display device is used for n hours. The “consumer attribute” indicates the attribute of a target viewer who views a content assigned to the display device. For example, in a display device in which consumer attributes of a gender “male” and an age “30s to 40s” are set, advertisements targeted at the consumer with the consumer attributes are set to be displayed. For example, for a display device that can be viewed from a location frequently passed by “male” and “30s to 40s”, “male” and “30s to 40s” are assigned as consumer attributes, and for a display device that can be viewed from a location frequently passed by “female” and “20s to 30s”, “female” and “20s to 30s” are assigned as consumer attributes.

The elements indicating the display conditions of the display device are not limited thereto, and various elements such as “installation location,” “aspect ratio,” and “resolution” may be used. In addition, content information includes a display time. The display time is a period from the start of playback of the content to the end of playback. Regarding the display time of the content, when contents are different from each other, some contents have the same display time, but some contents have different display times. When the extraction unit 114 extracts a replacement display device, the extraction unit 114 may also refer to the display time of the content and extract contents with the same display time or contents with a small difference in display time. The information on the display time of the content is stored in the storage unit 111 together with an identifier of the content.

(step S104) The content server 11 compares information on a faulty display device with information on other normal display devices, and specifies a display device that is closest to the information on the faulty display device among the normal display devices. For example, it is assumed that the display device 12-A is faulty. In this case, when the information on the display device 12-A is compared with the information on the other display devices 12-B to 11-E by using the database shown in FIG. 5, the display device 12-E includes a large number of same elements and is thus a display device with close information. That is, in this example, in the display device 12-A and the display device 12-E, the elements of “screen size” and “consumer attributes of target” are the same. In addition, the element of “fee” is the closest. Thus, the display device 12-E is a display device with the closest information. When the content server 11 specifies a display device that is closest to the faulty display device among the normal display devices, this specified display device is determined as a replacement display device.

(step S105) The content server 11 distributes an advertisement content that was being displayed on the faulty display device to the replacement display device instead of the faulty display device. At this time, when there is another advertisement content already being displayed on the replacement display device, the advertisement content on the faulty display device is added to the other advertisement content and displayed.

The following method can be applied as a display method when an advertisement content on a faulty display device is added to another advertisement content already being displayed on a replacement display device and is displayed.

(1) A screen of the replacement display device is divided, and the other advertisement content that had been displayed until then and the advertisement content on the faulty display device are displayed in the respective divided screen regions.

(2) The other advertisement content that had been displayed on the replacement display device until then and the advertisement content on the faulty display device are switched by scrolling at predetermined time intervals and alternately displayed in a slide show format.

That is, FIG. 6 is a diagram showing an example of composite display of advertisement contents in the first embodiment of the present invention. This example shows a method of dividing a screen of a replacement display device and displaying another advertisement content that had been displayed until then and an advertisement content on a faulty display device in the respective divided screen regions.

For example, it is assumed that a failure occurs in the display device 12-A and the display device 12-E is specified as a display device with information closest to that of the display device 12-A. In this case, as shown in FIG. 6, the screen of the display device 12-E, which is a replacement display device, is divided into areas AR1 and AR2. Then, an advertisement content C1 (first advertisement content) that has been displayed on the display device 12-A is displayed in the area AR1, and an advertisement content C2 (second advertisement content) to be displayed on the display device 12-E is displayed in the area AR2.

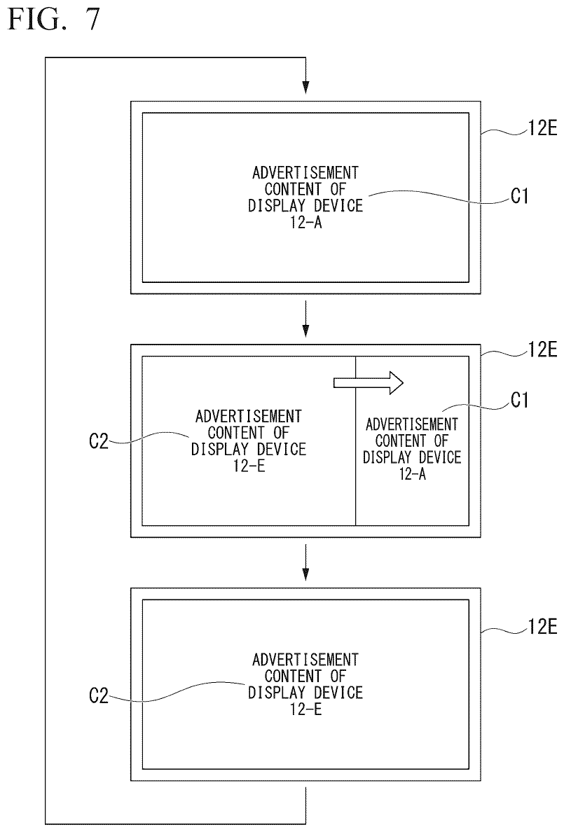

FIG. 7 is a diagram showing another example of composite display of advertisement contents in the first embodiment of the present invention. This example shows a method of switching another advertisement content that had been displayed until then on a replacement display device and an advertisement content on a faulty display device at predetermined time intervals and alternately displaying them in a slide show format.

For example, it is assumed that a failure occurs in the display device 12-A, and the display device 12-E is specified as a display device with information closest to that of the display device 12-A. In this case, as shown in FIG. 7, first, the advertisement content C1 (first advertisement content) that has been displayed on the faulty display device 12-A is displayed for a certain period of time, content display is scrolled and switched, and then the advertisement content C2 (second advertisement content) to be displayed on the display device 12-E is displayed for a certain period of time. This operation is repeated.

When a content in a slide show format is created, it is necessary to set a display time for each advertisement. The display time for each advertisement is set in the same manner as when the faulty display device was displaying advertisements in a slide show format, and thus the display time can be obtained in advance in step S102, or a fixed value can be set in the CMS of the content server 11.

In addition, when an advertisement content on a faulty display device is added to another advertisement content that has already been displayed on a replacement display device and is displayed, whether to display it on a divided screen or in a slide show format can be determined uniquely, or an advertising client can select it.

### Second Embodiment

Next, a second embodiment of the present invention will be described. The second embodiment of the present invention, shows a configuration of a targeted signage. The targeted signage refers to a system that selects a content to be displayed in accordance with the attributes of consumers who view advertisements.

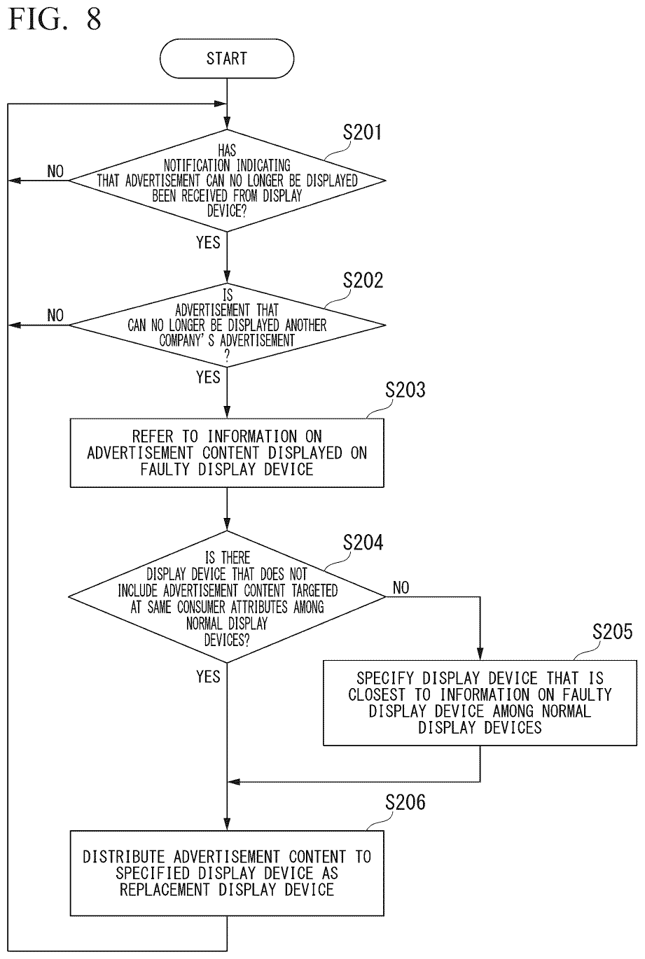

FIG. 8 is a flowchart showing a process in a digital signage system according to the second embodiment of the present invention. This flowchart shows a process in a targeted signage when a failure occurs in one of the display devices 12-A, 12-B, 12-C, . . .

(step S201) The content server 11 determines whether it has received a notification indicating that an advertisement can no longer be displayed from each of the display devices 12-A, 12-B, 12-C, . . . When the content server 11 has not received a notification indicating that an advertisement can no longer be displayed from any of the display devices 12-A, 12-B, 12-C, . . . (step S201: No), the content server 11 returns the process to step S201. On the other hand, when the content server 11 has received a notification indicating that an advertisement can no longer be displayed (step S201: Yes), the content server 11 causes the process to proceed to step S202.

(step S202) The content server 11 determines whether the advertisement content that can no longer be displayed is own company's advertisement or another company's advertisement. When the advertisement content that can no longer be displayed is own company's advertisement (step S202: No), the content server 11 returns the process to step S201. Here, when own company's advertisement can no longer be displayed, it is not necessary to display it on a replacement display device. In this case, since it is not necessary to prepare a replacement display device, a display device on which another company's advertisement is displayed does not need to be used as a replacement display device, and the other company's advertisement can be displayed preferentially. Thereby, it is possible to prevent the own company's advertisement from affecting an advertisement frame of the other company's advertisement. On the other hand, when the advertisement content that can no longer be displayed is the other company's advertisement (step S202: Yes), the content server 11 causes the process to proceed to step S203. By causing the process to proceed to step S203, the other company's advertisement can be displayed on the replacement display device when the advertisement content that can no longer be displayed is the other company's advertisement.

The processes from step S201 to step S203 are the same as the processes from step S101 to step S103 in the first embodiment.

(step S203) The content server 11 refers to consumer attributes of an advertisement content displayed on a faulty display device. That is, in a targeted signage, an advertisement content is displayed in accordance with the attributes of a consumer who will view the advertisement. Information on the consumer attributes is written in a database of the display device. In step S203, the content server 11 refers to the information on the consumer attributes of the advertisement content. When the targeted signage is used, a display time of an advertisement is the duration of a viewer's viewing, and thus information on the display time of the advertisement can be made unnecessary.

(step S204) The content server 11 determines whether there is a display device that does not include an advertisement content targeted at the same consumer attributes as the consumer attributes of the faulty display device among the normal display devices.

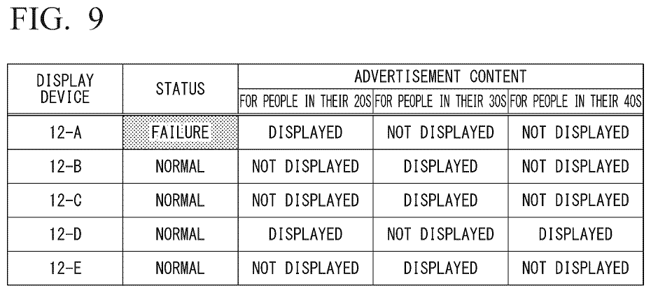

FIG. 9 is a diagram of a database which is an example of display conditions of a display device in the second embodiment of the present invention. The display conditions of the display device may be stored in the storage unit 111 in advance.

For example, when a failure occurs in the display device 12-A, the consumer attributes of the display device 12-A from the database shown in FIG. 9 are “displayed” for “for people in their 20s” and “not displayed” for “for people in their 30s” and “for people in their 40s”. Thus, when display devices that do not include an advertisement content with a consumer attribute “for people in their 20s” are extracted from the example in FIG. 9, the display devices 12-B, 12-D, and 12-E are searched for.

When the content server 11 cannot search for a display device that does not include an advertisement content targeted at the same consumer attributes as those of the faulty display device (step S204: No), the content server 11 causes the process to proceed to step S205. When the content server 11 can search for a display device (step S204: Yes), the content server 11 causes the process to proceed to step S206.

(step S205) The content server 11 specifies a display device that is closest to the faulty display device among the normal display devices, and causes the process to proceed to step S206. The process at this time is the same as the process of step S104 in the first embodiment.

(step S206) The content server 11 distributes and adds an advertisement content that was being displayed on the faulty display device to the advertisement content assigned to the replacement display device. For example, when a failure has occurred in the display device 12-A, the display devices 12-B, 12-D, and 12-E are searched for by the process of step S204. For example, when the display device 12-B is used as the replacement display device, the display device 12-B performs display as follows.

(1) When a viewer is in his/her 20s:

The display device 12-B displays an advertisement content “for people in their 20s”of the faulty display device 12-A.

(2) When a viewer is in his/her 30s:

The display device 12-B displays an advertisement content “for people in their 30s”of the display device 12-B.

(3) When a viewer is in his/her 40s:

The display device 12-B does not display an advertisement.

As described above, in the second embodiment of the present invention, in step S204, a replacement display device is specified by searching for display devices that do not include an advertisement content targeted at the same consumer attributes as the consumer attributes of the faulty display device. Thereby, the advertisement content on the replacement display device is not affected.

That is, when a failure occurs in the display device 12-A and the display device 12-B is used as a replacement display device, an advertisement content “for people in their 20s” is not set in the display device 12-B, and thus there will be no competition for an advertising content “for people in their 20s”. In addition, an advertisement content “for people in their 30s” is not set in the display device 12-A, and thus the opportunity to display the advertisement content “for people in their 30s” that was set in the display device 12-B will not be lost.

When a display device that does not include an advertisement content targeted at the same consumer attributes as those of the faulty display device cannot be searched for in step S204 (step S204: No), a display device closest to the faulty display device is specified in step S205 and used as a replacement display device. In this case, an advertisement content targeted at the same consumer attributes may compete. For example, when a failure occurs in the display device 12-A and the display device 12-D is used as a replacement display device, the advertisement content “for people in their 20s” of the display device 12-A and the advertisement content “for people in their 20s” set in the display device 12-D compete with each other, affecting the opportunity to display the advertisement content “for people in their 20s” set in the display device 12-D. In this case, it is considered that advertisement contents targeted at the same consumer attributes are alternately displayed. In addition, as in the first embodiment, it is considered that a screen is divided to display two advertisement contents.

As described above, in the second embodiment of the present invention, when a failure occurs in a display device, a replacement display device is specified by comparing consumer attributes of an advertisement content on a faulty display device with consumer attributes of advertisement contents on other normal display devices. When a display device that does not include an advertisement content targeted at the same consumer attributes is searched for, it is possible to avoid losing the opportunity to display an advertisement content on the replacement display device.

Furthermore, when a failure occurs in a display device, consumer trends may be determined using consumer attributes of an advertisement content of the display device to specify a replacement display device. For example, display devices that display advertisement contents “for people in their 20s” are often installed in places where there is a high traffic of people in their 20s. For this reason, when a failure occurs in a display device, a display device with the same consumer attributes as those of the advertisement content on the faulty display device may be specified as a replacement display device.

For example, when the consumer attribute of the advertisement content on the faulty display device is “for people in their 20s,” a display device with a consumer attribute of “for people in their 20s” is specified as a replacement display device. In this manner, display advertisements “for people in their 20s” can be efficiently displayed for viewers in their 20s.

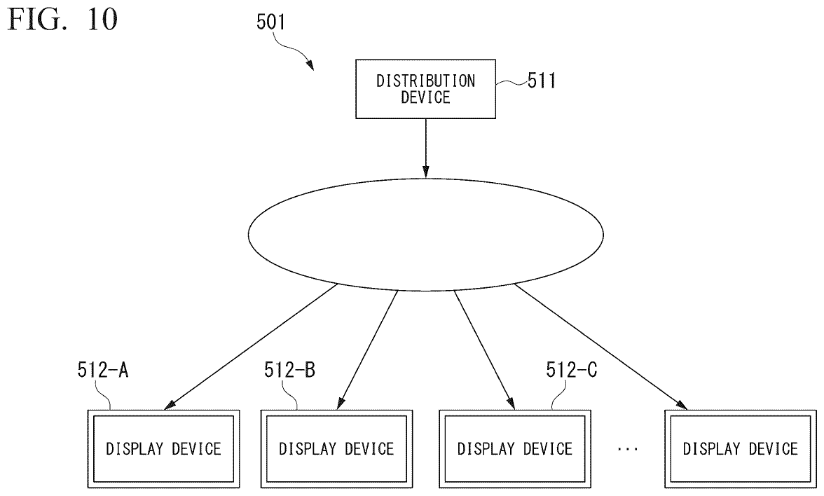

FIG. 10 shows a basic configuration of an advertisement display device in another embodiment of the present invention.

A content display system 501 in another embodiment of the present invention includes a distribution device 511 that distributes contents, and a plurality of display devices 512-A, 512-B, 512-C, . . . The distribution device 511 displays a content by transmitting the content to the plurality of display devices 512-A, 512-B, 512-C, . . .

When the distribution device 511 detects a display device in which a failure has occurred among the plurality of display devices, a replacement display device is extracted from one of the display devices in which a failure has not been detected, on the basis of the degree of similarity between display conditions of the display device in which no failure has been detected and display conditions of the display device in which a failure has been detected. Then, the distribution device 511 distributes a content that was to be displayed on the display device in which a failure has been detected to the extracted replacement display device, and displays it.

When the distribution device 511 detects a failure in a display device, a replacement display device may be extracted from among the display devices for which no failure has been detected, in accordance with a correspondence between consumer attributes of a content assigned to be displayed on the display device in which are failure has been detected and consumer attributes of a content assigned to be displayed on the display device in which no failure has been detected.

The entirety or a part of the digital signage system 1 in the above-described embodiment may be implemented by a computer. In this case, a program for implementing this function may be recorded on a computer-readable recording medium, and the program recorded on this recording medium may be read into a computer system and executed to implement the function. It is assumed that the term “computer system” here includes hardware such as an OS and peripheral devices. In addition, the term “computer-readable recording medium” refers to portable media such as flexible disks, optical magnetic disks, ROMs, and CD-ROMs, and storage devices such as hard disks built into computer systems. Furthermore, the term “computer-readable recording medium” may include a medium that dynamically stores a program for a short period of time, such as a communication line when transmitting a program via a network such as the Internet or a communication line such as a telephone line, and a medium that stores a program for a certain period of time, such as a volatile memory inside a computer system that serves as a server or client in such a case. The above-mentioned program may also be one that implements a part of the above-mentioned function, one that can implement the above-mentioned function in combination with a program already recorded in the computer system, or one that can be implemented using a programmable logic device such as an FPGA.

Although the embodiments of the present invention have been described above in detail with reference to the drawings, the specific configurations are not limited to these embodiments, and the present invention also includes designs within the scope of the gist of the present invention.

### REFERENCE SIGNS LIST

11 Content server
12A, 12B, 12C Display device
13 Terminal device
14 Network

What is claimed is:

1. A content display method executed by a distribution device that is communicatively connected to a plurality of display devices and that is configured to distribute a content to the plurality of display devices, the content display method comprising:
detecting a failure display device, in which a failure has occurred, from among the plurality of display devices;
extracting a replacement display device from one or more non-failure display devices, in which any failure has not been detected, the one or more non-failure display devices being included in the plurality of display devices, wherein the extraction is made on the basis of the degree of similarity in terms of display condition between the one or more non-failure display devices and the failure display device; and
transmitting a content, which had once been assigned to be displayed on the failure display device, toward the replacement display device as extracted, and to allow the replacement display device to display the content.

2. A content display method executed by a distribution device that is communicatively connected to a plurality of display devices and that is configured to distribute a content to the plurality of display devices, the content display method comprising:
detecting a failure display device, in which a failure has occurred, from among the plurality of display devices;
extracting a replacement display device from one or more non-failure display devices, in which any failure has not been detected, the one or more non-failure display devices being included in the plurality of display devices, wherein the extraction is made in accordance with a correspondence, in terms of a consumer attribute of a content assigned to be displayed, between the failure display device and the non-failure display device; and
transmitting a content, which had once been assigned to be displayed on the failure display device, toward the replacement display device as extracted, and to allow the replacement display device to display the content.

3. The content display method according to claim 1, wherein,
for displaying a first content assigned to be displayed on the failure display device on the replacement display device, if that there is a second content assigned to be displayed on the replacement display device, then the first content and the second content are extracted, and
the first content and the second content as extracted are transmitted to the replacement display device.

4. The content display method according to claim 2, wherein,
for displaying a first content assigned to be displayed on the failure display device on the replacement display device, if that there is a second content assigned to be displayed on the replacement display device, then the first content and the second content are extracted, and
the first content and the second content as extracted are transmitted to the replacement display device.

5. The content display method according to claim 3, wherein
the replacement display device is configured to divide a display region of the replacement display device into a plurality of divided display regions, and
the first content and the second content are transmitted to the replacement display device,
the replacement display device is configured to display the first content in a first region of the plurality of divided display regions, and to display the second content in a second region of the plurality of divided display regions.

6. The content display method according to claim 4, wherein
the replacement display device is configured to divide a display region of the replacement display device into a plurality of divided display regions, and
the first content and the second content are transmitted to the replacement display device,
the replacement display device is configured to display the first content in a first region of the plurality of divided display regions, and to display the second content in a second region of the plurality of divided display regions.

7. The content display method according to claim 3, wherein the first content and the second content are transmitted to the replacement display device,
the replacement display device is configured to display the first content and the second content sequentially and non-simultaneously over time on a display screen of the replacement display device.

8. The content display method according to claim 4, wherein the first content and the second content are transmitted to the replacement display device,
the replacement display device is configured to display the first content and the second content sequentially and non-simultaneously over time on a display screen of the replacement display device.

9. The content display method according to claim 1, wherein
if the content assigned to be displayed on the failure display device is a distribution-company-placed content that has been placed by a distribution company that provides a service or services of distributing and displaying any content on the plurality of display devices, then the replacement display device is configured not to display the distribution-company-placed content, and
if the content assigned to be displayed on the failure display device is a non-distribution-company-placed content that is placed by a non-distribution company different from the distribution company, the content is transmitted to the replacement display device for display.

10. The content display method according to claim 2, wherein
if the content assigned to be displayed on the failure display device is a distribution-company-placed content that has been placed by a distribution company that provides a service or services of distributing and displaying any content on the plurality of display devices, then the replacement display device is configured not to display the distribution-company-placed content, and
if the content assigned to be displayed on the failure display device is a non-distribution-company-placed content that is placed by a non-distribution company different from the distribution company, the content is transmitted to the replacement display device for display.

11. The content display method according to claim 2, wherein, from among the non-failure display devices, a non-failure display device having a non-correspondence in terms of a consumer attribute of a content assigned to be displayed on the non-failure display device, to the consumer attribute of a content assigned to be displayed on the failure display device is extracted as the replacement display device.

12. The content display method according to claim 2, wherein, from among the non-failure display devices, a non-failure display device having a correspondence in terms of a consumer attribute of a content assigned to be displayed on the non-failure display device, to the consumer attribute of a content assigned to be displayed on the failure display device is extracted as the replacement display device.

13. A distribution device communicatively connected to a plurality of display devices and configured to distribute a content to the plurality of display devices, the distribution device comprising:
a detection unit configured to detect, among the plurality of display devices, a failure display device in which a failure has occurred;
an extraction unit configured to extract a replacement display device from one or more non-failure display devices, in which any failure has not been detected, the one or more non-failure display devices being included in the plurality of display devices; and
a transmission unit configured to transmit, to the replacement display device, a content which has once been assigned to be displayed on the failure display device.
